(19) United States
(12) Patent Application Publication
(10) Pub. No.: US 2018/0216877 A1
(43) Pub. Date: Aug. 2, 2018

(54) METHOD AND SYSTEM FOR PROCESSING A LIQUID NATURAL GAS STREAM AT A LNG IMPORT TERMINAL

(71) Applicant: SHELL OIL COMPANY, Houston, TX (US)

(72) Inventors: Marcel Filip DABKOWSKI, Rijswijk (NL); Laurens Joseph Arnold Marie VAN CAMPEN, Amsterdam (NL); Pablo Antonio VEGA PEREZ, Rijswijk (NL)

(21) Appl. No.: 15/748,531

(22) PCT Filed: Jul. 27, 2016
(86) PCT No.: PCT/EP2016/067924

§ 371 Date: Jan. 29, 2018

(30) Foreign Application Priority Data
Jul. 31, 2015 (EP) 15179320.5

(51) Int. Cl. F25J 1/00; F17C 9/00; F17C 7/04

(52) U.S. Cl. CPC F25J 1/0025; F17C 2270/0171; F17C 9/00; F17C 7/04; F17C 2221/033; F17C 2223/0161; F17C 2223/033; F17C 2223/035; F17C 2223/043; F17C 2223/046; F17C 2225/0123; F17C 2225/0184; F17C 2225/035; F17C 2225/043; F17C 2227/0135; F17C 2250/043; F17C 2250/0626; F17C 2250/0631; F17C 2250/0636; F17C 2265/03; F17C 2265/034; F17C 2265/061; F17C 2265/066; F17C 2270/0136; F25J 1/0092

(57) ABSTRACT

The invention relates to a of processing a liquid natural gas stream at a LNG import terminal. The method comprises operating a vaporization unit obtaining a pressurized vaporized natural gas stream and operating a slushification unit to obtain a slush of liquid and solids and a cooled vapour phase. The method further comprises withdrawing the cooled vapour phase from the slushifier providing a cooled vapour stream and passing the cooled vapour stream to the vaporization unit.

The present invention relates to a method and system for processing a liquid natural gas stream.

When importing natural gas as liquid natural gas (LNG), the LNG needs to be regasified before being ready for the market. LNG import terminals or regasification terminals are built to transform the liquid natural gas back into a pressurized gaseous phase before being fed to the gas grid.

At the same time, there is an increasing demand for making LNG available in liquid form to end-consumers, for instance as fuel for transport (e.g. vehicles, trucks, ships). Customers buy LNG in liquid form and store it in a fuel tank. The LNG is regasified before use, e.g. inside the vehicle.

A drawback of liquefied natural gas is that boil off gas is produced due to heat ingress. Boil off gas limits the amount of time the liquefied natural gas can be stored, e.g. inside a fuel tank without intermittent pressure control measures.

Instead of liquid LNG, a methane comprising slush or slush LNG may be produced, slush being a mixture of solid and liquid natural gas. Methods of producing a methane comprising slush or slush LNG are known.

Slush LNG has the advantage that less or no boil off gas is produced as long as solid natural gas particles are present. Also, the density of slush LNG is higher than the density of liquid natural gas allowing more molecules to be stored and transported in a given volume, such as a fuel tank.

Japanese patent document JP2003314954 describes a slush LNG manufacturing method in which solid LNG and liquid LNG are mixed. A liquid nitrogen tank is mounted in a liquefied natural gas tank, and a solid matter obtained by solidifying the liquefied natural gas is produced on a heat transfer face of a surface of the liquid nitrogen tank and scraped off by an auger to be mixed with the liquefied natural gas. JP2003314954 has the disadvantage that it requires substantial and complex hardware (rotating/moving equipment), which also makes it difficult to scale up this process. Furthermore, an additional refrigeration cycle for the nitrogen refrigerant is needed which requires a relatively large amount of cooling energy.

NBS Report 9758, Slush and boiling methane characterisation, by C. f. Sindt et al (U.S. Department of

Commerce, National Bureau of Standards, Institute for basic standards, Boulder, Colorado 80302 (Jul. 1, 1970) describes an experimental, batchwise production apparatus for producing slush LNG. Batchwise production of slush LNG is not suitable for use in a continuous manufacturing method.

EP1876404A1 describes an apparatus for producing nitrogen slush. U.S. Pat. No. 4,009,013 describes a process for preparing fine-grained slush of low-boiling gasses, such as e.g. nitrogen or hydrogen.

US2013139544 provides a system and method for optimizing the recondensation of boiloff gas in liquid natural gas storage tanks.

It is an object to provide a method of and system for receiving a liquid natural gas stream and make it available for the market in an efficient manner.

The present invention provides a method of processing a liquid natural gas stream, the method comprises

a) operating a vaporization unit (A) by:
providing a first liquid natural gas stream (10) from one or more storage tanks (1),
pressurizing the first liquid natural gas stream (10) providing a pressurized liquid natural gas stream (12),
vaporizing the pressurized liquid natural gas stream (12) obtaining a pressurized vaporized natural gas stream (14),
   b) operating a slushification unit (B) by:
providing a second liquid natural gas stream (20) from the one or more storage tanks (1),
passing the second liquid natural gas stream (20) to a slushifier (21) in which the second liquid natural gas stream (20) is cooled down and depressurized to triple point conditions of the liquid natural gas stream (20) to obtain a slush of liquid and solids (22) and a cooled vapour phase (23),
withdrawing the cooled vapour phase (23) from the slushifier (21) providing a cooled vapour stream (24) and
passing the cooled vapour stream (24) to the vaporization unit (A).

According to a further aspect there is provided a system for processing a liquid natural gas stream, the system comprises a vaporization unit (A), wherein the vaporization unit (A) comprises
a pressurizer unit (11) arranged to receive a first liquid natural gas stream (10) from one or more storage tanks (1) and generate a pressurized liquid natural gas stream (12),
a vaporizer (13) arranged to receive the pressurized liquid natural gas stream (12) and generate a pressurized vaporized natural gas stream (14),
   wherein the system further comprises a slushification unit (B), wherein the slushification unit (B) comprises
a slushifier (21) arranged to receive a second liquid natural gas stream (20) from the one or more storage tanks (1) and generate a slush of liquid and solids (22) and a cooled vapour stream (24),
   wherein the vaporization unit (A) is in fluid communication with the slushification unit (B) to receive at least part of the cooled vapour stream (24).

The one or more storage tanks may be part of the system or may be separate from the system.

The fluid communication between the vaporization unit (A) and the slushification unit (B) may be provided by one or more lines arranged to convey the cooled vapour stream, such as a conduit or tube.

The slushification unit (B) may comprises a slush vessel and an expansion-cooling device, such as one or more parallel throttle or expansion valves or one or more parallel spray nozzles (27), wherein the expansion-cooling device is positioned in the flow path of the second liquid natural gas stream (20) to the slush vessel.

According to a further aspect there is provided a slush of liquid and solids obtained by the method or system described above, wherein the slush is a mixture of solid and liquid natural gas.

So, the slush comprises a mixture of solid and liquid natural gas, the solid mainly comprising methane and the liquid mainly comprising methane.

The liquid natural gas streams and the slush of liquid and solids primarily consists of methane, i.e. at least 50 mol % methane, typically at least 75 mol % methane.

The liquid natural gas streams and the slush of liquid and solids may further comprise heavier carbons, such as ethane, propane, (iso-)butane, (iso-)pentane. Typically, the mol fractions of heavier hydrocarbon components are smaller than the mol fractions of lighter hydrocarbon components.

The liquid natural gas streams and the slush of liquid and solids may further comprise a small fraction of nitrogen.

The liquid natural gas stream has a unique triple point pressure and triple point temperature depending on the exact composition. A person skilled in the art will be able to determine the exact triple point pressure and triple point temperature for a given composition. For 100% methane the triple point conditions are −182.47° C. (90.68 K) at 0.11688 bar.

The invention will be further illustrated hereinafter, using examples and with reference to the drawing in which;

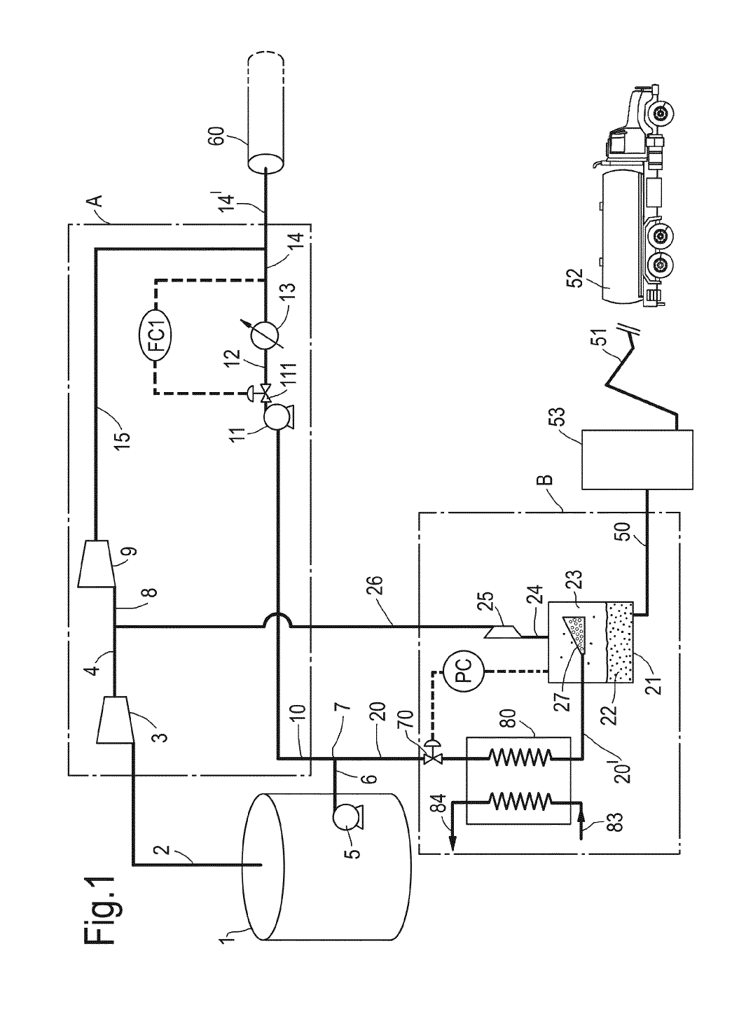

FIG. 1 schematically shows an embodiment,

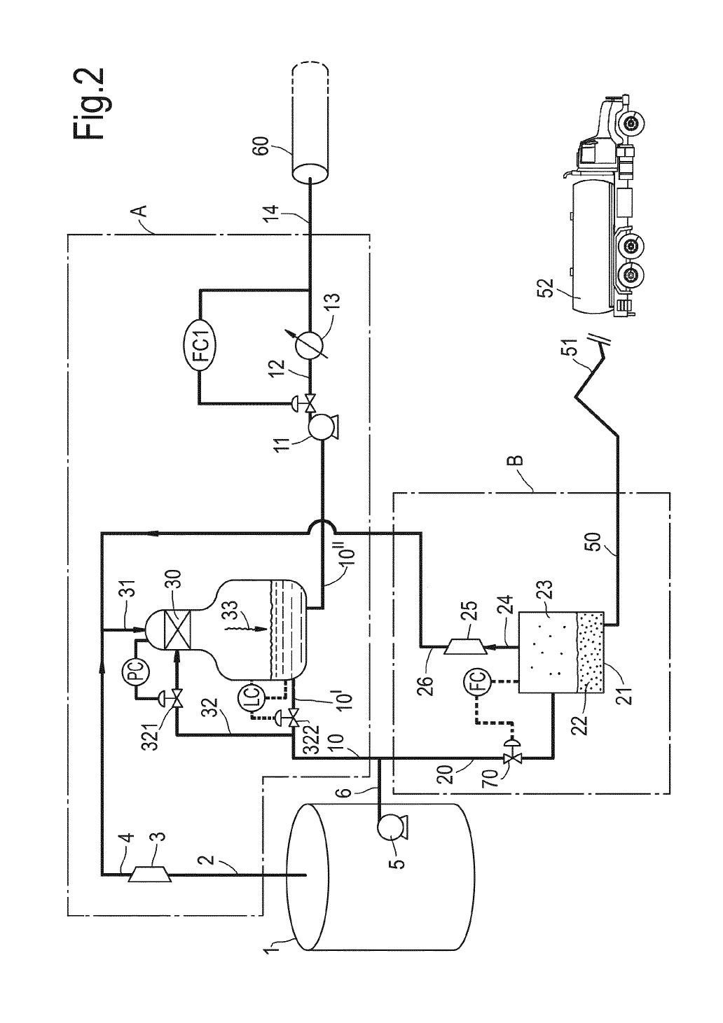

FIG. 2 schematically shows an alternative embodiment and

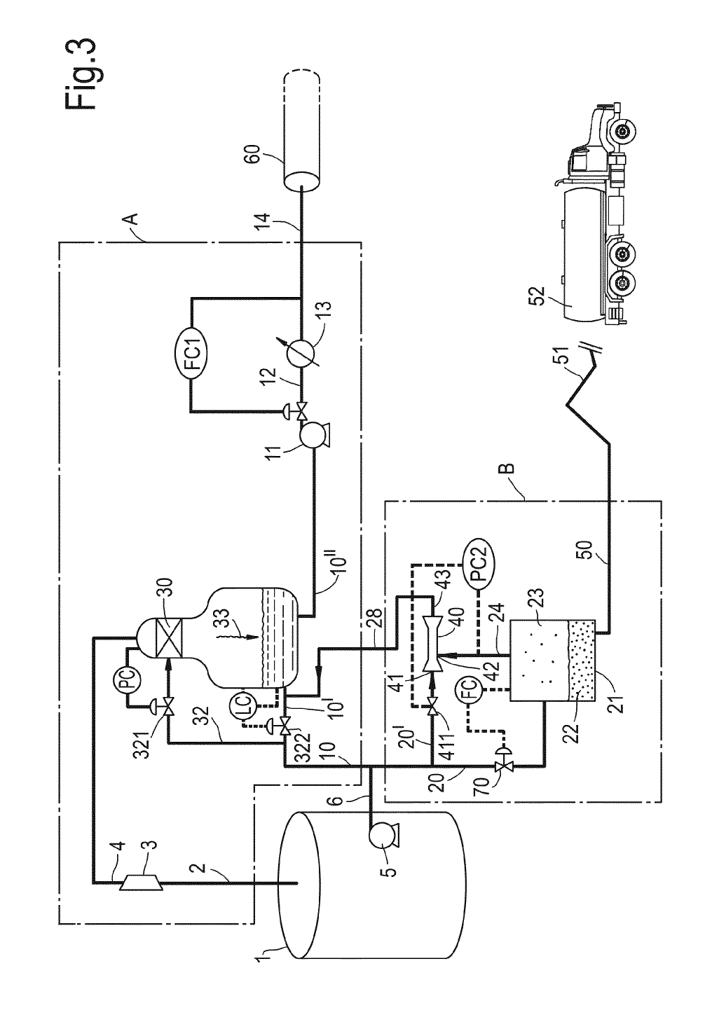

FIG. 3 schematically shows a further alternative embodiment.

In these figures, same reference numbers will be used to refer to same or similar parts. Furthermore, a single reference number will be used to identify a conduit or line as well as the stream conveyed by that line.

It is presently proposed to provide a vaporization unit to revaporize or regasify a liquid natural gas stream and a slushification unit to produce a slush or mixture of solid and liquid from a liquid natural gas, where the vaporization unit and the slushification unit function in parallel, wherein a certain integration is provided between the vaporization unit and the slushification unit.

This method provides an efficient way of processing liquid natural gas and prepare it for the market. A first part is revaporized and prepared to be passed into the gas grid, while a second part is slushified and made available for further transportation via trucks or barges or to be used as fuel, e.g. for transport. By integrating the vaporisation and the slushification, slushification can be done in a relatively efficient manner, as the withdrawn cooled vapour stream can be combined with the vaporization unit, for instance can be combined with a boil-off gas stream from the storage tanks.

FIG. 1 shows an embodiment schematically showing the vaporization unit A and the slushification unit B. Further shown is storage tank 1, which in use comprises liquid natural gas. The liquid natural gas may be stored under substantially atmospheric pressure (i.e. in the range of 0-250 mbarg, e.g. 150 mbarg) at a temperature of approximately −160° C. The liquid natural gas may also be stored under higher pressure and a higher temperature, such as a pressure greater than 2 bar, greater than 10 bar or even greater than 12 bar. According to an example, the first pressure may be 15 bar. At such a pressure, the temperature of the liquid methane comprising stream may be −115° C.

In the embodiment described below it is assumed that the liquid natural gas is stored in the storage tank at substantially atmospheric pressure, i.e. within 15% from the atmospheric pressure.

A first liquid natural gas stream 10 and a second liquid natural gas stream 20 are obtained from the storage tank 1.

Obtaining the first and second liquid natural gas streams 10, 20 from the storage tank 1 may be done using one or more pumping devices 5 provided in the storage tank or downstream thereof. The first and second liquid natural gas streams 10, 20 may typically be provided at a pressure in the range of 4-14 barg, for instance 12 barg.

As shown in FIG. 1, first a main liquid natural gas stream 6 may be obtained from the storage tank 1 using the one or more pumping devices 5 and the first and second liquid natural gas streams 10, 20 are obtained by splitting the main liquid natural gas stream 6, for instance by using a splitter or a T-junction 7 or the like.

The pressure of the first and second liquid natural gas streams 10, 20 may be in the range of 5-15 barg, for instance 13 barg.

The splitter 7 may be a controllable splitter or T-junction 7 arranged to control a flow rate of the second liquid natural gas stream 20. Alternatively, the flow rate of the first and or second liquid natural gas streams may be controlled by appropriate valves (shown as valve 70, discussed in more detail below) positioned downstream of the splitter or T-junction.

The split ratio between the first and second liquid natural gas streams 10, 20 may be controlled, in particular actively controlled and adjusted constantly or regularly during use. The split ratio may be defined as the flow rate of the second liquid natural gas stream 20 divided by the sum of the first and second liquid natural gas streams 10, 20.

The split ratio may be in the range 0-0.50 or 0-0.25.

According to an embodiment, the split ratio may be binary controlled to either equal a first value or equal a second value, the first value being smaller than the second value. The first value may be associated with a situation of no or less demand for slush. The first value may be zero or close to zero to prevent the piping of the slushification unit from warming up. The second value may be associated with high demand for slush and may be in the range 0.01-0.5 or 0.01-0.25.

In case there is no demand for slush or there is a sufficient amount of slush present in storage, the split ratio may be 0.

The split ratio may be additionally or alternatively be influenced by a flow controller FC which adjusts the setting of the valve 70 in response to a parameter measured in the slushifier, such as a level of the slush inside the slushifier, a temperature, a pressure, a solid fraction, viscosity of the slush generated in the slushifier.

The vaporization unit A is arranged to receive the first liquid natural gas stream 10 from the one or more storage tanks 1 and pressurize the first liquid natural gas stream 10 to provide a pressurized liquid natural gas stream 12. The vaporization unit A comprises a pressurizer unit 11 such as a pump. The pressurizer unit 11 comprises an inlet to receive the first liquid natural gas stream 10 and an outlet to discharge the pressurized liquid natural gas stream 12.

In particular in the embodiment described with reference to FIG. 1, the pressurizer unit 11 and the pumping device 5 may be incorporated in single device.

The vaporization unit A is further arranged to receive the pressurized liquid natural gas stream 12 to obtain a pressurized vaporized natural gas stream 14. The vaporization unit A comprises a vaporizer 13 comprising an inlet to receive the pressurized liquid natural gas stream 12 from the pressurizer unit 11 and an outlet discharging the pressurized vaporized natural gas stream 14.

The vaporizer 13 comprises a heat exchanger in which the pressurized liquid natural gas stream 12 can exchange heat with a warming medium, such as ambient water or air. Examples of vaporizers 13 can for instance be found in WO2013186271, WO2013186275, WO2013186277 and WO2008012286.

The pressurized vaporized natural gas stream 14 typically has a temperature close to ambient temperatures and a pressure above 50 bar, for instance above 65 bar, such as 80 bar.

The pressurized vaporized natural gas stream 14 is then passed to the gas grid 60.

The vaporization unit may comprise a controller to control one or more of the pressure, flow rate (energy, mass, volume) of the pressurized vaporized natural gas stream 14 (or combined natural gas stream 14′, described below) that is passed to the gas grid 60. By way of example, FIG. 1 shows a flow controller FC1 which controls the flow rate towards the vaporizer in response to a measured parameter of the vaporized natural gas stream 14, e.g. by controlling a controllable valve 111.

The slushification unit B is arranged to receive the second liquid natural gas stream 20 from the one or more storage tanks 1.

Different types of slushification units B may be used.

Typically, the slushification unit B comprises a slushifier which creates a mixture of solid and liquid natural gas, in particular a pumpable mixture, with a cooled vapour phase 23. The cooled vapour phase 23 is withdrawn providing a cooled vapour stream 24 which is passed to the vaporization unit A. This way the vaporization unit A and the slushification unit B are integrated.

A suitable slushification unit B will be described below.

The slushification unit B comprises a slushifier, comprising a slush vessel 21 having an inlet to receive the second liquid natural gas stream 20. The slushifier is arranged to reduce the pressure of the second liquid natural gas stream 20 to about triple point pressure to form slush, the slush being a mixture of solid and liquid natural gas, in particular a pumpable mixture.

Optionally, as shown in FIG. 1, the second liquid natural gas stream 20 may be passed through a sub-cooling heat exchanger 80 in which the second liquid natural gas stream 20 is subcooled prior to entering the slush vessel 21. The method may thus comprise
sub-cooling the second liquid natural gas stream 20 to obtain a sub-cooled second liquid natural gas stream 20′,
passing the sub-cooled second liquid natural gas stream 20′ to the slush vessel 21 in which the second liquid natural gas stream 20 is further cooled down and depressurized to triple point conditions.

The slushifier may comprise a sub-cooler heat exchanger 80, and sub-cooling the second liquid natural gas stream 20 comprises:
passing the second liquid natural gas stream 20 through the sub-cooling heat exchanger 80.

The sub-cooling heat exchanger 80 comprises an inlet 81 which is arranged to receive the second liquid natural gas stream 20 and an outlet 82 which is in fluid communication with the inlet of the slush vessel 21 to discharge a sub-cooled second liquid natural gas stream 20.

The sub-cooling heat exchanger 80 further may comprise a refrigerant flow path 83, 84 through which a suitable sub-cooling refrigerant can flow to provide cooling duty to the second liquid natural gas stream 20.

A suitable sub-cooling refrigerant may flow through the refrigerant flow path 83, 84 wherein sub-cooling the second liquid natural gas stream 20 is done with a sub-cooling refrigerant cycle in which a sub-cooling refrigerant, such as nitrogen, is cycled. The sub-cooling refrigerant cycle may obtain cooling duty from vaporizing the pressurized liquid natural gas stream 12 obtaining a pressurized vaporized natural gas stream 14 in vaporizer 13.

In practice, the sub-cooled second liquid natural gas stream may have a temperature below the boiling point of the second natural gas stream 20 and above the triple point temperature of the second natural gas stream 20.

It will be understood that sub-cooling may also be employed in the other embodiments described, in particular the embodiments described with reference to FIGS. 2 and 3.

The slushifier may cool and depressurize the second (sub-cooled) liquid natural gas stream 20 to about triple point conditions of the second liquid natural gas stream 20 to obtain a slush of liquid and solids 22 and a cooled vapour phase 23. This is accomplished by passing the (sub-cooled) second liquid natural gas stream 20 (20′) to the slush vessel 21 which is kept a lower pressure at or close to the triple point pressure of the natural gas stream 20, thereby cooling and at least partially solidifying and evaporating the second liquid natural gas 20. The evaporation will withdraw enthalpy thereby cooling the non-evaporated portion of the stream (auto-thermal process). Together with the Joule Thompson effect created when introducing the stream in the slush vessel sufficient cooling is obtained to reach the triple point temperature.

This cooling and depressurizing may be done by expansion-cooling the second liquid natural gas stream 20 into the slush vessel. Expansion-cooling can be done over one or more parallel throttle or expansion valves or can be done by spray-cooling via one or more parallel spray nozzles 27.

A cooled vapour phase 23 will be obtained which will be present above the slush 22. The triple point conditions will be obtained and maintained by withdrawing the cooled vapour phase 23 from the slushifier 21 via conduit 24 using an appropriate vapour withdrawal device. The vapour withdrawal device may be a compressor or pump 25 or an eductor (shown in FIG. 3), thereby obtaining a compressed vapour stream 26.

By withdrawing the cooled vapour phase 23 the pressure inside the slush vessel 21 can be actively controlled. The method may comprise controlling the pressure inside the slush vessel 21 by varying or cycling the pressure in time to thereby control a solid fraction being produced and to thereby control a solid fraction in the mixture 40 collected and thereby ensure that a pumpable mixture of solid and liquid is created in the slush vessel.

When the pressure/temperature in the slush vessel is controlled to be above the triple point, no solids are generated. When the pressure/temperature in the slush vessel 21 is controlled to be below the triple point a relatively high solid fraction is generated. As the desired solid fraction in the methane comprising slush may be lower than the solid fraction generated when operating below the triple point, the pressure in the slush vessel 21 may be cycled in time between above and below the triple point, to obtain the desired solid fraction.

This way the second pressure can be varied slightly to control the solid fraction in the slush vessel.

The slush vessel 21 is a vessel able to withstand a certain underpressure with respect to its environment and may therefore also be referred to as a vacuum vessel.

The hereby obtained (compressed) cooled vapour stream 24 26 is passed to the vaporization unit (A).

According to an embodiment the method comprises
obtaining a boil-off gas stream 2 from the one or more storage tanks 1.

The boil-off gas stream is obtained from the one or more storage tanks 1 to prevent pressure built-up. The boil-off gas stream 2 may be compressed by a boil-off compressor 3 compressing the boil-off gas stream 2 providing a compressed boil-off gas stream 4.

According to an embodiment, of which an example is shown in FIG. 1, passing the cooled vapour stream 24 to the vaporization unit A comprises
compressing the vapour stream 24 providing a compressed vapour stream 26,
combining the compressed vapour stream 26 with the compressed vaporized natural gas stream 14 providing a combined natural gas stream 14′.

The compressed vapour stream 26 typically has a pressure well below pressure of the pressurized vaporized natural gas stream 14, so the vaporization unit A may comprise an additional compressor 9 arranged to receive the compressed vapour stream 26 to obtain a further compressed vapour stream 15 with a pressure substantial equal to the pressure of the pressurized vaporized natural gas stream 14 and substantially equal to the pressure of the gas grid 60, typically 50 bar or more, e.g. 80 bar. The combined stream can be passed to the gas grid 60.

Compressing the vapour stream 24 may be done by passing the vapour stream through a compressor 25 to obtain the compressed vapour stream 26.

According to an embodiment the method further comprises
compressing the boil-off gas stream 2 providing a compressed boil-off gas stream 4,
combining the compressed boil-off gas stream 4 and the compressed vapour stream 26 with the pressurized vaporized natural gas stream (14) providing a combined natural gas stream (14′).

Combination of these streams can be accomplished in different ways and orders, for instance as shown in FIG. 2, wherein the compressed vapour stream 26 is first combined with compressed boil-off gas stream 4, yielding stream 8, which is passed to additional compressor 9 arranged to receive the compressed vapour stream 26 to obtain a further compressed vapour stream 15 which is then combined with the pressurized vaporized natural gas stream 14.

Compressing the boil-off gas stream 2 may be done by passing the boil-off gas stream through a compressor 3 to obtain the compressed boil-off gas stream 4.

The boil-off gas stream 2 may typically have a pressure of 100 mbarg, where the compressed boil-off gas stream 4 has a pressure of typically 6-10 barg, e.g. 8 barg. The compressed vapour stream 26 may have a pressure substantially equal to the compressed boil-off gas stream 4.

This provides an advantageous way of combining the boil-off gas stream 2 and the vapour stream 24 obtained from the slushifier 21.

Another embodiment will now be described with reference to FIG. 2.

According to this embodiment the method comprises
compressing the boil-off gas stream 2 providing a compressed boil-off gas stream 4,
feeding a vapour recondenser feed stream 31 to a recondenser 30, the vapour recondenser feed stream 31 comprising at least part of the compressed boil-off gas stream 4,
passing a liquid recondenser feed stream 32 to the recondenser 30, the liquid recondenser feed stream 32 comprising a side-stream 32 taken from the first liquid natural gas stream 10,
obtaining a recondensed stream 33 from the vapour recondenser feed stream 31 and the liquid recondenser feed stream 32,
combining the recondensed stream 33 with a remainder of the first liquid natural gas stream 10′ obtaining a re-combined first liquid natural gas stream 10″.

The remainder of the first liquid natural gas stream is the part of the first liquid natural gas stream not being the side-stream 32.

The flow rate of the remainder of the first liquid natural gas stream 10′ may be controlled by a level controller LC by means of a controllable valve 322 in response to a measured liquid level below the recondensor 30.

The re-combined first liquid natural gas stream 10″ is then pressurized using pressurizer unit 11 to provide a pressurized liquid natural gas stream 12.

The side-stream 32 can by-pass the recondenser 30, in which case combining with the recondensed stream 33 takes place downstream of the recondenser. Alternatively, the side-stream can be passed to the bottom of the recondenser 30, in which case combining with the recondensed stream 33 takes place in the bottom part of the recondenser.

Passing the liquid recondenser feed stream 32 to the recondenser 30, may be controlled by a pressure controller PC which controls the flow rate of the recondenser feed stream 32 by means of a controllable valve 321 in response to a pressure reading providing an indication of the pressure in the recondensor 30.

According to an embodiment passing the cooled vapour stream 24 to the vaporization unit A comprises
compressing the vapour stream 24 providing a compressed vapour stream 26,

and wherein the vapour recondenser feed stream 31 further comprises the compressed vapour stream 26.

The embodiment described with reference to FIG. 2 has the advantage that additional compressor 9 can be omitted.

A further embodiment will be described with reference to FIG. 3.

According to an embodiment operating the slushification unit B, in particular withdrawing the cooled vapour phase 23 from the slushifier 21 providing a cooled vapour stream 24, comprises:
feeding a third liquid natural gas stream 20′ as motive stream to a motive stream inlet 41 of an eductor 40,
feeding at least part of the cooled vapour stream 24 to a suction stream inlet 42 of the eductor 40,
obtaining an eductor outlet stream 28 from an eductor outlet 43, and
passing the eductor outlet stream 28 comprising the motive stream and the cooled vapour stream 24 to the vaporization unit A.

The third liquid natural gas stream 20′ may be obtained as a side-stream from the second liquid natural gas stream 20, but may also be obtained as a side-stream from the first liquid natural gas stream 10 or directly from the one or more storage tanks 1.

The eductor outlet stream 28 may be passed to the vaporization unit A in a similar manner as explained above with reference to FIG. 1, i.e. by compressing the stream and combining it with the pressurized vaporized natural gas stream 14 providing a combined natural gas stream 14′.

A flow rate of the motive stream may be controlled by a controllable valve 411 which is controlled by a pressure controller PC2 which controls the controllable valve 411 in response to a measurement reading providing an indication of the operational status of the slushifier, such as a pressure of the cooled vapour stream 24, a pressure of the cooled vapour phase 23 inside the slush vessel 21, the solid fraction, the viscosity or a combination thereof.

Alternatively the vapour recondenser feed stream 31 may comprise the eductor outlet stream 28.

According to an embodiment shown in FIG. 3 the eductor outlet stream 28 is re-combined with the recondensed stream 33 or with the first liquid natural gas stream 10″.

Combining with the recondensed stream 33 can take place downstream of the recondenser or at the bottom of the recondenser.

According to an embodiment the method further comprises
obtaining a slush stream 50 from the slushifier 21 and—feeding the slush stream 50 to a slush dispenser 51.

The slush dispenser may be a nozzle or any other device suitable for dispensing an amount of slush to a (fuel) tank 52, such as a tank on a transportation means, such as a vehicle, vessel or plane. The transportation means may use the slush as fuel or may transport the slush as cargo to a destination or both.

The vehicle may be a cryogenic road truck comprising a cryogenic tank to transport the slush LNG to retail stations where it is stored.

The vessel may be a marine bunker vessel which is equipped to move to remote marine locations to provide slush fuel to other vessels.

Feeding the slush stream to the slush dispenser 51 may comprise first feeding the slush stream to an intermediate slush storage vessel 53 (as shown in FIG. 1) and when needed, feeding the slush stream from the intermediate slush storage vessel 53 to the slush dispenser 51.

According to an embodiment operating the slushification unit B is interrupted or continued at a minimum when there is no demand for slush and is resumed when there is demand for slush. According to such an embodiment operating the slushification unit B comprises selectively switching between operating the slushification unit B at a production level and an interruption level, wherein a first flow rate of the second liquid natural gas stream 20 associated with the production level is greater than a second flow rate of the second liquid natural gas stream 20 associated with the interruption level. The second flow rate may be zero or may be non-zero in order to maintain a minimal flow through the slushification unit to keep the piping cold.

The slushification unit B may only be fully operated when there is a demand for slush, for instance when there is a transportation means present which needs to be refuelled or reloaded or when the amount of slush present in the intermediate slush storage vessel 53 has dropped under a predetermined level.

Operation of the vaporization unit A may continue when the operating the slushification unit B is interrupted or continued at interruption level.

The person skilled in the art will understand that the present invention can be carried out in many various ways without departing from the scope of the appended claims.

1. Method of processing a liquid natural gas stream, the method comprises
a) operating a vaporization unit by:
providing a first liquid natural gas stream from one or more storage tanks,
pressurizing the first liquid natural gas stream providing a pressurized liquid natural gas stream,
vaporizing the pressurized liquid natural gas stream obtaining a pressurized vaporized natural gas stream,
b) operating a slushification unit by:
providing a second liquid natural gas stream from the one or more storage tanks,
passing the second liquid natural gas stream to a slushifier in which the second liquid natural gas stream is cooled down and depressurized to triple point conditions of the liquid natural gas stream to obtain a slush of liquid and solids and a cooled vapour phase,
withdrawing the cooled vapour phase from the slushifier providing a cooled vapour stream and
passing the cooled vapour stream to the vaporization unit.

2. Method according to claim 1, wherein the method comprises
obtaining a boil-off gas stream from the one or more storage tanks.

3. Method according to claim 1, wherein passing the cooled vapour stream to the vaporization unit comprises
compressing the vapour stream providing a compressed vapour stream,
combining the compressed vapour stream with the compressed vaporized natural gas stream providing a combined natural gas stream.

4. Method according to claim 2, wherein the method further comprises
compressing the boil-off gas stream providing a compressed boil-off gas stream
combining the compressed boil-off gas stream and the pressurized vapour stream with the compressed vaporized natural gas stream providing a combined natural gas stream.

5. Method according to claim 2, wherein the method comprises
compressing the boil-off gas stream providing a compressed boil-off gas stream,
feeding a vapour recondenser feed stream to a recondenser, the vapour recondenser feed stream comprising at least part of the recompressed boil-off gas stream,
passing a liquid recondenser feed stream to the recondenser, the liquid recondenser feed stream comprising a side-stream taken from the first liquid natural gas stream,
obtaining a recondensed stream from the vapour recondenser feed stream and the liquid recondenser feed stream,
combining the recondensed stream with a remainder of the first liquid natural gas stream obtaining a re-combined first liquid natural gas stream.

6. Method according to claim 5, wherein passing the cooled vapour stream to the vaporization unit comprises
compressing the vapour stream providing a compressed vapour stream,
and wherein the vapour recondenser feed stream further comprises the compressed vapour stream.

7. Method according to claim 1, wherein operating the slushification unit comprises:
feeding a third liquid natural gas stream as motive stream to a motive stream inlet of an eductor,
feeding at least part of the cooled vapour stream to a suction stream inlet of the eductor,
obtaining an eductor outlet stream from an eductor outlet, and
passing the eductor outlet stream comprising the motive stream and the cooled vapour stream to the vaporization unit.

8. Method according to claim 5, wherein the vapour recondenser feed stream comprises the eductor outlet stream.

9. Method according to claim 5, wherein the eductor outlet stream is re-combined with the recondensed stream or with the first liquid natural gas stream.

10. Method according to claim 1, wherein the method further comprises
obtaining a slush stream from the slushifier and—feeding the slush stream to a slush dispenser.

11. Method according to claim 1, wherein the method comprises
sub-cooling the second liquid natural gas stream to obtain a sub-cooled second liquid natural gas stream,
passing the sub-cooled second liquid natural gas stream to the slush vessel in which the second liquid natural gas stream is further cooled down and depressurized to triple point conditions.

12. Method according to claim 11, wherein the slushifier comprises a sub-cooler heat exchanger, and sub-cooling the second liquid natural gas stream comprises:
passing the second liquid natural gas stream 404 through the sub-cooling heat exchanger.

13. Method according to claim 11, wherein sub-cooling the second liquid natural gas stream is done with a sub-cooling refrigerant cycle.

14. Method according to claim 1, wherein operating the slushification unit comprises selectively switching between operating the slushification unit at a production level and an interruption level, wherein a first flow rate of the second liquid natural gas stream associated with the production level is greater than a second flow rate of the second liquid natural gas stream associated with the interruption level.

15. System for processing a liquid natural gas stream, the system comprises a vaporization unit, wherein the vaporization unit comprises
a pressurizer unit arranged to receive a first liquid natural gas stream from one or more storage tanks and generate a pressurized liquid natural gas stream,
a vaporizer arranged to receive the pressurized liquid natural gas stream and generate a pressurized vaporized natural gas stream,
wherein the system further comprises a slushification unit, wherein the slushification unit comprises
a slushifier arranged to receive a second liquid natural gas stream from one or more storage tanks and generate a slush of liquid and solids and a cooled vapour stream,
wherein the vaporization unit is in fluid communication with the slushification unit to receive at least part of the cooled vapour stream.

16. System according to claim 15, wherein the slushification unit comprises a slush vessel and an expansion-cooling device, such as one or more parallel throttle or expansion valves or one or more parallel spray nozzles, wherein the expansion-cooling device is positioned in the flow path of the second liquid natural gas stream to the slush vessel.

17. Slush of liquid and solids obtained by claim 1, wherein the slush is a mixture of solid and liquid natural gas.

18. Slush of liquid and solids obtained by claim 15, wherein the slush is a mixture of solid and liquid natural gas.
